(19) United States
(12) Patent Application Publication
(10) Pub. No.: US 2025/0033989 A1
(43) Pub. Date: Jan. 30, 2025

(54) Solution-Processed Laminar Growth of Li3VO4 (LVO) Anode for Ultra-Long Cycling in High-Rate Metal-Ion Batteries

(71) Applicant: INDIA INSTITUTE OF TECHNOLOGY DELHI, New Delhi (IN)

(72) Inventors: Madhusudan SINGH, New Delhi (IN); Amit GUPTA, New Delhi (IN); Tejveer Singh ANAND, New Delhi (IN); Aashish JOSHI, New Delhi (IN)

(73) Assignee: INDIA INSTITUTE OF TECHNOLOGY DELHI, New Delhi (IN)

(21) Appl. No.: 18/786,396

(22) Filed: Jul. 26, 2024

(30) Foreign Application Priority Data
Jul. 28, 2023 (IN) 202311051106

(51) Int. Cl. C01G 31/02; H01M 4/02; H01M 4/04; H01M 4/1391; H01M 4/62; H01M 4/66; H01M 10/054

(52) U.S. Cl. CPC C01G 31/02; H01M 4/0404; H01M 4/1391; H01M 4/623; H01M 4/625; H01M 4/661; H01M 10/054; C01P 2002/01; C01P 2002/72; C01P 2004/03; C01P 2004/04; C01P 2006/40; H01M 2004/027

(57) ABSTRACT

The present invention generally relates to the field of electro-chemical and energy storage technology. In particular, the present invention relates to the laminar growth mechanism of the Li₃VO₄ (LVO) anode material and its ultra-long cycling under high C-rate for its application in metal ion batteries such as lithium-ion batteries, sodium ion batteries, or Zinc ion batteries.

### CROSS-REFERENCE TO A RELATED APPLICATION

The present application claims priority on India Patent Application No. 202311051106, filed Jul. 28, 2023, which is incorporated herein by reference in its entirety.

### FIELD OF INVENTION

The present invention generally relates to the field of electro-chemical and energy storage technology. In particular, the present invention relates to the laminar growth mechanism of the Li₃VO₄ (LVO) anode material and its ultra-long cycling under high C-rate for its application in metal ion batteries such as lithium-ion batteries, sodium ion batteries, or Zinc ion batteries.

### BACKGROUND OF INVENTION

As technology advances, rechargeable metal-ion batteries such as lithium-ion batteries (LIBs) have gained immense popularity for their benefits. They power a vast range of electronic devices, from portable gadgets like cameras, laptops, and smartwatches to electric vehicles and energy storage systems. However, like any technology, there is room for improvement. Graphite anodes, commonly used in these batteries, are plagued by safety issues and poor performance. The instability of these electrode materials leads to high lithium dendrites formation [1] and large polarization during lithiation, ultimately causing capacity fading [2]. Furthermore, the formation of a stable solid electrolyte interface (SEI) layer is critical to prevent the reaction of electrolytes at the surface of the electrode material. Thick SEI layers impede the intercalation and deintercalation of Li⁺ ions during subsequent charging and discharging, resulting in poor battery cycle performance and irreversible capacity loss during initial cycles [3]. Additionally, graphite anodes undergo significant volumetric expansion during cycling, resulting in poor adhesion and peeling off the coated slurry from the current collector, leading to a short circuit. Thus, there is an urgent need for batteries with higher energy and power density, increased safety, and excellent large-current charging-discharging properties to power larger-scale applications. In addition to the above, recently Li₃VO₄ is a promising material for lithium-ion batteries due to its high energy density, safe working potential, and theoretical capacity of 394 mAh/g (when cycled between 0.1-3 V) [4] [5]. However, it has poor cycling and rate performance due to low electronic conductivity and resistance polarization [6]. To address these challenges, researchers have explored the utilization of suitable binders and conductive fillers. Different morphologies of LVO have been developed, such as carbon-coated core-shell LVO [7], nanorods [8], and mesoporous-supported LVO [9] structures, to improve its performance. LVO anode also undergoes small volume expansion (˜4%) when discharged to 0.7 V [10].

The present patent disclosure relates to the solution-processed synthesis of crystalline laminar (sheet-like) LVO with surfactant free approach. The LVO anode was tested in the half-cell configuration for over 30,000 cycles under a potential window of 0.02-3 V at 23 C-rate. The results were impressive, as the cell delivered a specific discharge capacity of approximately 150-170 mAh/g at the 15000^{th} cycle with a coloumbic efficiency (CE) of >95%. Even after persistent deep charging, the cell could still deliver a capacity of 100-160 mAh/g at the end of 30K cycles. It was noticed that the capacity initially fell for a few cycles during the GCD profile of the LVO, but then it started increasing for the rest of the cycles (discussed in the coming section). Overall, the laminar LVO anode seems to be performing very well under these conditions and could be a potential material in the electric vehicles EV sector. The detailed literature comparative analysis of the LVO is shown in Table. (1) & (2).

### OBJECTS OF THE INVENTION

The principal object of this invention is to provide a solution-based, cost-effective, and surfactant-free technique designed LVO anode (with laminar morphology) for developing and producing metal-ion batteries, such as lithium-ion batteries, sodium ion batteries, or Zinc ion batteries.

Another object of this invention is to demonstrate the exceptional cycling performance, with the ability to cycle for over 30,000 cycles at 20+C rate.

### SUMMARY OF THE INVENTION

The present patent disclosure provides a solution-processed synthesis of crystalline laminar (sheet-like) LVO with surfactant free approach by a sol-gel method. The morphology associated with the synthesis route described here leads to the laminar (layered) structure of LVO. The battery's slurry fabrication process involves vigorous stirring and sonication before coating on battery-graded foil.

The LVO anode was tested in the half-cell configuration for over 30,000 cycles under a potential window of 0.02-3 V at 23 C-rate. The results were remarkable, wherein the cell delivered a specific discharge capacity of approximately 150-170 mAh/g at the 15000” cycle with a coloumbic efficiency (CE) of >95%. Even after persistent deep charging, the cell could still deliver a capacity of 100-160 mAh/g at the end of 30K cycles. It was noticed that the capacity initially fell for a few cycles during the GCD profile of the LVO, but then it started increasing for the rest of the cycles (discussed in the coming section). Considering the capacity fading per cycle by taking average capacity as a reference, the numerical value comes to around 0.00029 mAh/g throughout the cycling. This performance is considered excellent in cell performance under high rates and long cycling. Overall, the present work demonstrates the potential of laminar LVO anode materials for use in metal-ion batteries such as Li-ion batteries, sodium ion batteries, Zinc ion batteries. Overall, the laminar LVO anode performs very well under these conditions and is a potential material in the electric vehicle (EV) sector. Tables (1) and (2) present a comprehensive comparative analysis of the LVO based on the literature review.

### BRIEF DESCRIPTION OF ACCOMPANYING DRAWINGS

The patent application file contains at least one drawing executed in color. Copies of this patent or patent application publication with color drawing(s) will be provided by the Office upon request and payment of the necessary fee.

The drawings described herein are for illustrative purposes only of selected embodiments and not all possible implementations and are not intended to limit the scope of the present disclosure. Further objectives and advantages of this invention will be more apparent from the ensuing description when read in conjunction with the accompanying drawing and wherein:

FIG. 1 depicts schematic representation of LVO synthesis followed by slurry preparation and device fabrication (X:Y:Z, where X is the active material, Y is a conductive additive, and Z is binder. Y may or may not be further divided into P:Q, where P>Q (in mass) and are individually conductive materials, wherein P is carbon black and Q is MWCNT (multiwall carbon nanotubes).

FIG. 2 depicts (a) Powder XRD pattern of LVO, (b) FESEM, (c) TEM, (d) SAED of the Pristine LVO, and (e) ex-situ (after cycling) TEM of LVO after 30K cycles at 20+ C-rate.

FIG. 3 depicts (a) GCD, and (b) time (hour) vs. current/voltage profile of LVO half-cell under potential window of 3-0.02 V for 30K cycles at 20+ C-rate.

FIG. 4 depicts (a) Cyclic voltammogram (CV) test under various scan rate (0.1-2 mV/s), (b) charge-discharge profile under various C-rate, and (c) rate capability (RC) test of LVO∥Li half-cell under various C-rates (0.2, 0.5, 1 and 20 C) between potential window of 0.02-3 V.

FIG. 5 depicts (a) Cyclic voltammogram (CV) test under various scan rate (0.1-2 mV/s), (b) charge-discharge profile at 0.1 C, and (c) GCD cycling performance of LVO∥Na half-cell for 200 cycles at 0.2 C under potential window of 0.02-3 V.

FIG. 6 depicts (a) Cyclic voltammogram (CV) test under various scan rate (0.1-1.5 mV/s), (b) charge-discharge profile at 0.15 C, and (c) GCD cycling performance of LVO∥Zn half-cell for 200 cycles at 0.15 C under potential window of 0.2-1.6 V.

It will be recognized by the person of ordinary skill in the art, given the benefit of this disclosure, that then examples shown in the figures are not necessarily drawn to scale. Certain features or components may have been enlarged, reduced, or distorted to facilitate a better understanding of the illustrative aspects and examples disclosed herein. In addition, the use of shading, patterns, dashes, and the like in the figures is not intended to imply or mean any particular material or orientation unless otherwise clear from the context.

### DETAILED DESCRIPTION OF THE INVENTION

The following description includes the preferred best mode of one embodiment of the present invention. It will be clear from this description of the invention that the invention is not limited to these illustrated embodiments but that the invention also includes a variety of modifications and embodiments thereto. Therefore, the present description should be illustrative and not limiting. While the invention is susceptible to various modifications and alternative constructions, it should be understood that there is no intention to limit the invention to the specific form disclosed, but, on the contrary, the invention is to cover all modifications, alternative constructions, and equivalents falling within the spirit and scope of the invention as defined in the claims. In any embodiment described herein, the open-ended terms “comprising,” “comprises,” and the like (which are synonymous with “including,” “having,” and “characterized by”) may be replaced by the respective partially closed phrases “consisting essentially of,” consists essentially of,” and the like or the respective closed phrases “consisting of,” “consists of, and the like. As used herein, the singular forms “a”, “an,” and “the” designate both the singular and the plural unless expressly stated to designate the singular only.

As used herein, the phrases Li₃VO₄, or LVO are used interchangeably and refer to the product electroconductive material, anode (with laminar morphology) prepared by the claimed process of the present disclosure.

As used herein, the phrases “lithium source” or “lithium salt” are used interchangeably in the present disclosure.

As used herein, the phrases “vanadium source” or “Vanadium salt” are used interchangeably in the present disclosure.

The present patent disclosure provides a solution-processed synthesis of crystalline laminar (sheet-like) LVO with surfactant free approach by a sol-gel method. The morphology associated with the synthesis route described here leads to the laminar (layered) structure of LVO. The battery's slurry fabrication process involves vigorous stirring and sonication before coating on battery-graded foil.

A surfactant-free process, which eliminates the use of surface-active agents, offers several advantages. It is cost-effective, environmentally friendly, and yields purer end products. The simplified process enhances reproducibility and reduces waste generation. Moreover, it avoids surfactant-related challenges, improves safety, and is compatible with sensitive applications.

The present disclosure provides an electroconductive material comprising lithium vanadium oxide (LVO).

The present disclosure provides an electroconductive material for a metal-ion battery comprising lithium vanadium oxide (LVO).

In an embodiment of the present disclosure, the metal-ion battery is selected from a group comprising lithium-ion battery, sodium ion battery, or Zinc ion battery.

The present disclosure provides an electroconductive material for a lithium-ion battery comprising lithium vanadium oxide (LVO).

In an embodiment of the present disclosure, the electroconductive material is an anode.

In an embodiment of the present disclosure, the lithium based vanadium oxide compounds including but not limited to either Li₃VO₄ or LiVO₃.

In another embodiment of the present disclosure, the Li₃VO₄ comprises a Lithium (Li) precursor and a Vanadium (V) precursor.

In an embodiment of the present disclosure, the Li precursor is prepared by dissolving a lithium source or lithium salt in a solvent.

In another embodiment of the present disclosure, the lithium source or lithium salt is selected from a group comprising but not limited to lithium acetate dihydrate (LiOAc), lithium chloride (LiCl), or lithium hydroxide (LiOH).

In an embodiment of the present disclosure, the V precursor is prepared by dissolving vanadium salt in a solvent.

In another embodiment of the present disclosure, the vanadium source or vanadium salt is selected from a group comprising but not limited to ammonium metavanadate (NH₄VO₃), Vanadyl Sulphate (VOSO₄), ammonium metavanadate (NH₄VO₃), Vanadium (V) tripropoxide oxide (OV(OC₃H₇)₃), vanadyl acetylacetonate (C₁₀H₁₄O₅V), Vanadium(V) trisisopropoxide oxide (OV(OCH(CH₃)₂)₃), and Vanadium pentoxide (V₂O₅).

In yet another embodiment of the present disclosure, the Li precursor is prepared by dissolving Lithium acetate dihydrate in a solvent.

In still another embodiment of the present disclosure, the V precursor is prepared by dissolving NH₄VO₃ in a solvent.

The present disclosure provides a process for preparing laminar lithium vanadium oxide (Li₃VO₄) electroconductive material for a metal-ion battery, the process comprising:
a) dissolving a lithium source or salt in a solvent to obtain a Li precursor solution (solution-A);
b) dissolving a vanadium source or salt in a solvent to obtain a V precursor solution (solution-B);
c) adding the solution-A to the solution-B followed by heating, drying, and grinding it to obtain a powder 1e;
d) annealing the powder 1e to obtain a lithium vanadium oxide (Li₃VO₄);
e) grinding the Li₃VO₄ and a conductive additive to obtain a mixture 1e;
f) mixing a binder solution with the mixture 1e to obtain a slurry 1e and subsequently subjecting it to stirring to obtain a slurry-2e; and
g) coating the slurry-2e on battery-grade foil followed by evaporation to obtain the laminar lithium vanadium oxide (Li₃VO₄) electroconductive material.

The present disclosure provides a process for preparing laminar lithium vanadium oxide (Li₃VO₄) electroconductive material for a metal-ion battery, the process comprising:
a) dissolving a lithium source or lithium salt in a solvent to obtain a Li precursor solution (solution-A);
b) dissolving a vanadium source or vanadium salt in a solvent to obtain a V precursor solution (solution-B);
c) adding the solution-A to the solution-B followed by heating, drying and grinding it to obtain a powder 1;
d) annealing the powder 1 to obtain a lithium vanadium oxide (LVO);
e) grinding the LVO and a conductive additive to obtain a mixture 1;
f) mixing a binder solution with the mixture 1 to obtain a slurry-1 and subsequently subjecting it to stirring to obtain a slurry-2; and
g) coating the slurry-2 on battery-grade foil followed by evaporation to obtain the laminar lithium vanadium oxide (Li₃VO₄) electroconductive material.

In an embodiment of the present disclosure, the metal ion battery is selected from a group comprising but not limited to a lithium ion battery, sodium ion battery, or zinc ion battery.

In an embodiment of the present disclosure, the above process (steps a to g) provides the electroconductive material that acts as an anode.

In an embodiment of the present disclosure, in step (a), lithium salt is lithium acetate dihydrate (LiOAc).

In an embodiment of the present disclosure, in step (b), vanadium salt is ammonium metavanadate (NH₄VO₃).

In an embodiment of the present disclosure, in step (a), Lithium acetate dihydrate (LiOAc) is dissolved in a solvent to obtain a Li precursor solution (solution-A).

In another embodiment of the present disclosure, in step (a), Lithium acetate dihydrate (LiOAc) is dissolved in an amount of about 5 ml to 70 ml in a solvent to obtain a Li precursor solution (solution-A) under constant stirring at a speed of about 500-1200 rpm and heating at a temperature ranging from about 20° C. to 80° C.

In yet another embodiment of the present disclosure, in step (a), Lithium acetate dihydrate (LiOAc) is dissolved in an amount of about 10 ml to 50 ml in a solvent to obtain a Li precursor solution (solution-A) under constant stirring at a speed of about 750-950 rpm and heated at a temperature ranging from about 35° C. to 65° C.

In an embodiment of the present disclosure, Lithium acetate dihydrate (LiOAc) is dissolved in a solvent in varying amounts, such as about 10 ml, 15 ml, 20 ml, 25 ml, 30 ml, 35 ml, 40 ml, 45 ml, or 50 ml.

In another embodiment of the present disclosure, the stirring in step (a) is conducted at various stirring speeds, such as about 500 rpm, about 550 rpm, about 600 rpm, about 650 rpm, about 700 rpm, about 750 rpm, about 800 rpm, about 850 rpm, about 900 rpm, about 950 rpm, about 1000 rpm, about 1050 rpm, about 1100 rpm, about 1150 rpm, or about 1200 rpm.

In yet another embodiment of the present disclosure, the heating in step (a) is performed at various temperatures, such as about 20° C., about 25° C., about 30° C., about 35° C., about 40° C., about 45° C., about 50° C., about 55° C., about 60° C., about 65° C., about 70° C., about 75° C., or about 80° C.

In an embodiment of the present disclosure, in step (b), ammonium metavanadate (NH₄VO₃) is dissolved in a solvent to obtain a V precursor solution (solution-B).

In an embodiment of the present disclosure, in step (b), ammonium metavanadate (NH₄VO₃) is dissolved in an amount of about 5 ml to 70 ml in a solvent to obtain a V precursor solution (solution-B).

In an embodiment of the present disclosure, ammonium metavanadate is dissolved in a solvent in varying amounts, such as about 5 ml, 10 ml, 15 ml, 20 ml, 25 ml, 30 ml, 35 ml, 40 ml, 45 ml, 50 ml, 55 ml, 60 ml, 65 ml, or 70 ml, In yet another embodiment of the present disclosure, in step (b), ammonium metavanadate (NH₄VO₃) is dissolved in an amount of about 10 ml to 50 ml in a solvent to obtain a V precursor solution (solution-B).

In an embodiment of the present disclosure, the solvent is a polar solvent.

In another embodiment of the present disclosure, the solvent is either alcohol or water.

In another embodiment of the present disclosure, the solvent is selected from a group comprising ethanol, methanol, 2-methoxy ethanol, propanol, or water.

In an embodiment of the present disclosure, in step (c), the solution-A is added to the solution-B followed by heating at a temperature ranging from 25° C. to 85° C. for a duration of about 8 hours to 30 hours.

In another embodiment of the present disclosure, the heating in step (c) is performed at various temperatures, such as about 25° C., about 30° C., about 35° C., about 40° C., about 45° C., about 50° C., about 55° C., about 60° C., about 65° C., about 70° C., about 75° C., about 80° C. or about 85° C.

In yet another embodiment of the present disclosure, the heating in step (c) is carried out for varying durations, such as about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, about 24 hours, about 25 hours, about 26 hours, about 27 hours, about 28 hours, about 29 hours, and about 30 hours.

In still another embodiment of the present disclosure, in step (c), the solution-A is added to the solution-B followed by heating at a temperature ranging from about 45° C. to 70° C. for a duration of about 12 hours to 24 hours.

In an embodiment of the present disclosure, in step (c), the mixture of solution A and solution B is dried at a temperature ranging from about 60° C. to 110° C. for a duration of about 1 to 5 hours to obtain a powder.

In another embodiment of the present disclosure, the powder obtained in step c) is a black-yellowish powder.

In another embodiment of the present disclosure, the drying in step (c) is performed at various temperatures, such as about 60° C., about 65° C., about 70° C., about 75° C., about 80° C., about 85° C., about 90° C., about 95° C., about 100° C., about 105° C., and about 110° C.

In yet another embodiment of the present disclosure, the drying in step (c) is carried out for varying durations, such as about 1 hour, 1 hour 30 minutes, 2 hours, 2 hours 30 minutes, 3 hours, 3 hours 30 minutes, 4 hours, 4 hours 30 minutes, 5 hours, 5 hours 30 minutes, or about 6 hours,

In another embodiment of the present disclosure, in step (c), the mixture of solution A & B is dried at a temperature ranging from about 80° C. to 95° C. for a duration ranging from about 3 to 5 hours to obtain a black-yellowish powder.

In an embodiment of the present disclosure, in step (d), the black-yellowish powder is annealed at a high temperature ranging from about 500° C. to 1200° C. for a duration ranging from about 1 hour to 8 hours to obtain a lithium vanadium oxide (LVO).

In another embodiment of the present disclosure, the annealing in step (d) is performed at various temperatures, such as about 500° C., about 550° C., about 600° C., about 650° C., about 700° C., about 750° C., about 800° C., about 850° C., about 900° C., about 950° C., about 1000° C., about 1050° C., about 1100° C., about 1150° C., or about 1200° C.

In yet another embodiment of the present disclosure, the annealing in step (d) is carried out for varying durations, such as about 1 hour, 1 hour 30 minutes, 2 hours, 2 hours 30 minutes, 3 hours, 3 hours 30 minutes, 4 hours, 4 hours 30 minutes, 5 hours, 5 hours 30 minutes, 6 hours, 6 hours 30 minutes, 7 hours, 7 hours 30 minutes, or about 8 hours.

In still another embodiment of the present disclosure, in step (d), the powder is annealed at a high temperature ranging from about 700° C. to 900° C. for a duration ranging from about 3 hours to 5 hours to obtain a lithium vanadium oxide (LVO).

In an embodiment of the present disclosure, in step (f), a binder solution is mixed with the mixture 1 to obtain a slurry-1 and subsequently subjected it to stirring at a speed of 500 rpm to 1500 rpm and ultra-sonication for a duration ranging from about 1 hour to 8 hours to obtain a slurry-2.

In another embodiment of the present disclosure, the stirring in step (f) is conducted at various stirring speeds, such as about 500 rpm, about 550 rpm, about 600 rpm, about 650 rpm, about 700 rpm, about 750 rpm, about 800 rpm, about 850 rpm, about 900 rpm, about 950 rpm, about 1000 rpm, about 1050 rpm, about 1100 rpm, about 1150 rpm, about 1200 rpm, 1250 rpm, 1300 rpm, 1350 rpm, 1400 rpm, 1450 rpm, or 1500 rpm.

In yet another embodiment of the present disclosure, the annealing in step (f) is carried out for varying durations, such as about 1 hour, 1 hour 30 minutes, 2 hours, 2 hours 30 minutes, 3 hours, 3 hours 30 minutes, 4 hours, 4 hours 30 minutes, 5 hours, 5 hours 30 minutes, 6 hours, 6 hours 30 minutes, 7 hours, 7 hours 30 minutes, or about 8 hours.

In another embodiment of the present disclosure, in step (f), a binder solution is mixed with the mixture 1 to obtain a slurry-1 and subsequently subjected it to stirring at a speed of 900 rpm to 1100 rpm and ultra-sonication for a duration of 3 hours to 6 hours to obtain a slurry-2.

In an embodiment of the present disclosure, in step (g), the battery grade foil is selected from a group comprising but not limited to Cu battery grade foil, carbon cloth battery grade foil, SS316 battery grade foil, Nickel battery grade foil, and graphite cloth battery grade foil.

In an embodiment of the present disclosure, in step (g), the slurry-2 is coated on Cu battery-grade foil followed by evaporation at a temperature ranging from about 40° C. to 100° C. to obtain the electroconductive material.

In another embodiment of the present disclosure, the evaporation in step (g) is performed at various temperatures, such as about 40° C., about 45° C., about 50° C., about 55° C., about 60° C., about 65° C., about 70° C., about 75° C., about 80° C., about 85° C., about 90° C., about 95° C., or about 100° C.

In another embodiment of the present disclosure, in step (g), the slurry-2 is coated on Cu battery-grade foil followed by evaporation at a temperature ranging from about 60° C. to 80° C. to obtain the electroconductive material.

The present disclosure provides a process for preparing laminar lithium vanadium oxide (Li₃VO₄) electroconductive material for a lithium-ion battery, the process comprising:
a) dissolving lithium acetate dihydrate (LiOAc) in a solvent to obtain a Li precursor solution (solution-A1);
b) dissolving ammonium metavanadate (NH₄VO₃) in a solvent to obtain a V precursor solution (solution-B1);
c) adding the solution-A1 to the solution-B1 followed by heating at a temperature ranging from about 25° C. to 80° C. for a duration ranging from about 3 hours to 30 hours, drying, and grinding it to obtain a powder 1a;
d) annealing the powder 1a to obtain a lithium vanadium oxide (Li₃VO₄);
e) grinding the Li₃VO₄ and a conductive additive to obtain a mixture 1a;
f) mixing a binder solution with the mixture 1a to obtain a slurry-1a and subsequently subjecting it to stirring and ultra-sonication to obtain a slurry-2a; and
g) coating the slurry-2a on battery-grade foil followed by evaporation to obtain the laminar lithium vanadium oxide (Li₃VO₄) electroconductive material.

The present disclosure provides a process for preparing laminar lithium vanadium oxide (Li₃VO₄) electroconductive material for a lithium-ion battery, the process comprising:
a) dissolving lithium acetate dihydrate (LiOAc) in an amount of about 5 ml to 70 ml, in a solvent to obtain a Li precursor solution (solution-A2) under constant stirring at a speed of 500-1200 rpm and heating at a temperature ranging from about 20° C. to 80° C.;
b) dissolving ammonium metavanadate (NH₄VO₃) in an amount of about 5 ml to 70 ml in a solvent to obtain a V precursor solution (solution-B2);
c) adding the solution-A2 to the solution-B2 followed by heating at a temperature ranging from about 30° C. to 85° C. for a duration ranging from about about 5 hours to 35 hours, drying at a temperature ranging from about 60° C. to 110° C., and grinding it to obtain a powder 1b;
d) annealing the powder 1b to obtain a lithium vanadium oxide (Li₃VO₄);
e) grinding the Li₃VO₄ and a conductive additive to obtain a mixture 1b;
f) mixing a binder solution with the mixture 1b to obtain a slurry-1b and subsequently subjecting it to stirring and ultra-sonication to obtain a slurry-2b; and
g) coating the slurry-2b on battery-grade foil followed by evaporation to obtain the laminar lithium vanadium oxide (Li₃VO₄) electroconductive material.

The present disclosure provides a process for preparing laminar lithium vanadium oxide (Li₃VO₄) electroconductive material for a lithium-ion battery, the process comprising:
a) dissolving lithium acetate dihydrate (LiOAc) in an amount of about 8 ml to 60 ml, in a solvent to obtain a Li precursor solution (solution-A3) under constant stirring at a speed of 600-1100 rpm and heating at a temperature ranging from 25° C. to 75° C.;
b) dissolving ammonium metavanadate (NH₄VO₃) in an amount of about 8 ml to 60 ml in a solvent to obtain a V precursor solution (solution-B3);
c) adding the solution-A3 to the solution-B3 followed by heating at a temperature ranging from about 35° C. to 80° C. for a duration of about 8 hours to 30 hours, drying at a temperature ranging from about 65° C. to 105° C. for a duration of about 1-5 hours, and grinding it to obtain a powder 1c;
d) annealing the powder 1c at a high temperature ranging from about 500° C. to 1200° C. for a duration ranging from about 1 hour to 8 hours to obtain a lithium vanadium oxide (Li₃VO₄); e) grinding the Li₃VO₄ and a conductive additive to obtain a mixture 1c;
f) mixing a binder solution with the mixture 1c to obtain a slurry-1c and subsequently subjecting it to stirring at a speed of 500 rpm to 1500 rpm and ultra-sonication for a duration ranging from about 1 hour to 8 hours to obtain a slurry-2c; and
g) coating the slurry-2c on battery-grade foil followed by evaporation at a temperature ranging from about 40° C. to 100° C. to obtain the laminar lithium vanadium oxide (Li₃VO₄) electroconductive material.

The present disclosure provides a process for preparing laminar lithium vanadium oxide (Li₃VO₄) electroconductive material for a lithium-ion battery, the process comprising:
a) dissolving lithium acetate dihydrate (LiOAc) in an amount of about 10 ml to 50 ml, in a solvent to obtain a Li precursor solution (solution-A4) under constant stirring at a speed of 750-950 rpm and heating at a temperature ranging from 35° C. to 65° C.;
b) dissolving ammonium metavanadate (NH₄VO₃) in an amount of about 10 ml to 50 ml in a solvent to obtain a V precursor solution (solution-B4);
c) adding the solution-A4 to the solution-B4 followed by heating at a temperature ranging from about 45° C. to 70° C. for a duration of about 12 hours to 24 hours, drying at a temperature ranging from about 80° C. to 95° C. for a duration of about 2 to 3 hours, and grinding it to obtain a powder 1d;
d) annealing the powder 1d at a high temperature ranging from about 700° C. to 900° C. for a duration of about 3 hours to 5 hours to obtain a lithium vanadium oxide (Li₃VO₄); e) grinding the Li₃VO₄ and a conductive additive to obtain a mixture 1d;
f) mixing a binder solution with the mixture 1d to obtain a slurry-1d and subsequently subjecting it to stirring at a speed of 900 rpm to 1100 rpm and ultra-sonication for a duration of 3 hours to 6 hours to obtain a slurry-2d; and
g) coating the slurry-2d on battery-grade foil followed by evaporation at a temperature ranging from about 60° C. to 80° C. to obtain the laminar lithium vanadium oxide (Li₃VO₄) electroconductive material.

The present disclosure provides a process for preparing Li₃VO₄ anode for a Zinc ion battery, the process comprising:
a) dissolving lithium acetate dihydrate (LiOAc) in an amount ranging from about 10 ml to 50 ml, in a solvent to obtain a Li precursor solution (solution-A4) under constant stirring at a speed of about 750-950 rpm and heating at a temperature ranging from about 35° C. to 65° C.;
b) dissolving ammonium metavanadate (NH₄VO₃) in an amount ranging from about 10 ml to 50 ml in a solvent to obtain a V precursor solution (solution-B4);
c) adding the solution-A4 to the solution-B4 followed by heating at a temperature ranging from about 45° C. to 70° C. for a duration of about 12 hours to 24 hours, drying at a temperature ranging from about 80° C. to 95° C. for a duration of about 2 to 3 hours, and grinding it to obtain a powder 1f;
d) annealing the powder 1f at a high temperature ranging from about 700° C. to 900° C. for a duration ranging from about 3 hours to 5 hours to obtain a lithium vanadium oxide Li₃VO₄;
e) grinding the Li₃VO₄ and a conductive additive to obtain a mixture 1f;
f) mixing a binder solution with the mixture 1f to obtain a slurry-1f and subsequently subjecting it to stirring at a speed of 900 rpm to 1100 rpm and ultra-sonication for a duration of 3 hours to 6 hours to obtain a slurry-2f; and
g) coating the slurry-2f on a battery grade foil followed by evaporation at a temperature ranging from about 60° C. to 80° C. to obtain the electroconductive material Li₃VO₄, wherein the battery grade foil is selected from a group comprising carbon cloth, SS316 foil, Nickel foil, or graphite cloth.

In an embodiment of the present disclosure, the above process requires active material (LVO), a conductive additive and a binder in a particular ratio which comprises of 70-80% of the active material, 10-25% of conducive fillers and 5-15% of binder by weight of the total batch size taken. These components are combined and mixed with a solvent to form a slurry.

In an embodiment of the present disclosure, the powder obtained in step c) is a black-yellowish powder.

In an embodiment of the present disclosure, in step f) the stirring is carried out by ultra-sonication.

In an embodiment of the present disclosure, the above process in step (f) requires solvent quantity sufficient to prepare a slurry when active material (LVO), conductive additive and binder or binder solution are combined together.

In an embodiment of the present disclosure, the binder solution is prepared by dissolving binder in a solvent.

In an embodiment of the present disclosure, the binder solution is prepared by dissolving a binder selected from a group comprising polyvinylidene-fluoride (PVDF), carboxymethylcellulose (CMC), or styrene-butadiene rubber (SBR) in a solvent either water or N-methyl-2-pyrrolidinone (NMP).

In an embodiment of the present disclosure, the binders can be used individually or in combination.

In an embodiment of the present disclosure, the binder solution is prepared by dissolving binder in NMP solvent.

In an embodiment of the present disclosure, the conductive additive is a mixture of carbon black and multiwall carbon nanotube.

In a non-limiting embodiment of the present disclosure, the conductive additive is further bifurcated into the mixture of carbon black and CNTs (MWCNT or SWCNT) which are in a varying ratios of about 8:2, 7:3 or 5:5, by weight of the total conductive filler used.

In a non-limiting embodiment of the present disclosure, the ratio of active material (Li₃VO₄): conductive additive: binder is selected from a group comprising 7:2:1, 9:0.5:0.5, 8:1:1, and 7:1:2.

In an embodiment of the present disclosure, the molarity range of ZnSO₄ aqueous electrolyte is between 1 to 4 M.

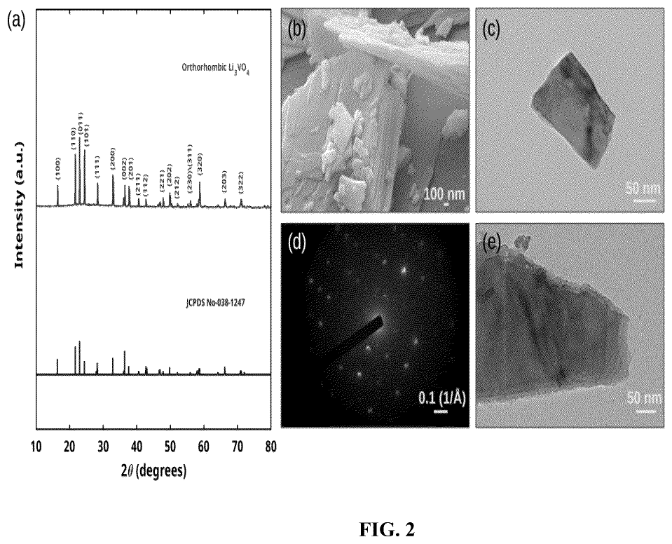

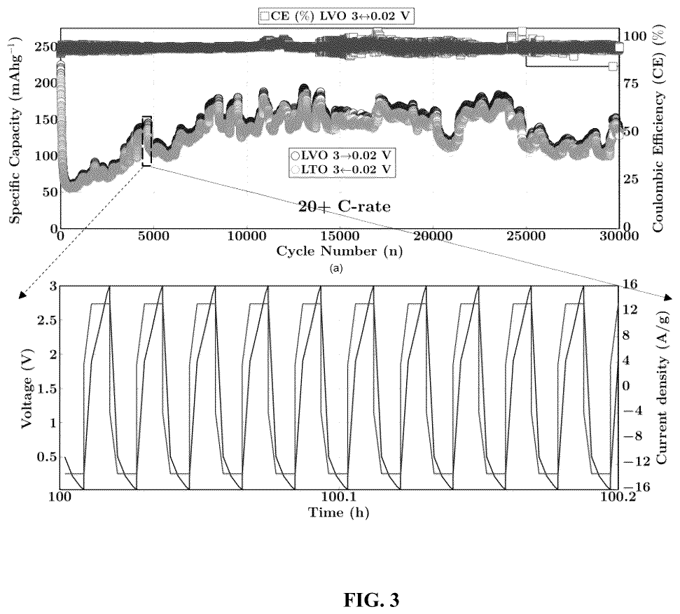

The present disclosure relates to a lithium vanadium oxide compound of formula Li₃VO₄, wherein the said compound is characterized by XRD, TEM including SAED (selected area electron diffraction) pattern which confirms the crystalline structure of Li₃VO₄ as described in FIGS. 2 and 3.

The present disclosure relates to a Solution-Processed Laminar Growth of Li₃VO₄ (LVO) anode for Ultra-Long Cycling in High-Rate Metal-Ion Batteries.

The present disclosure relates to a Metal-Ion Batteries comprising Li₃VO₄ (LVO) anode.

The present disclosure relates to Metal-Ion Batteries such as lithium-ion batteries, sodium ion batteries, or Zinc ion.

The present disclosure relates to Metal-Ion Batteries characterized which is tested with Li chemistry for its electrochemical performance.

The present disclosure relates to Metal-Ion Batteries such as lithium-ion batteries, which is tested with Li chemistry for its electrochemical performance.

The present disclosure relates to a laminar lithium vanadium oxide (Li₃VO₄) compound, characterized by:
a layered structure;
a composition comprising lithium (Li), vanadium (V), and oxygen (O) in a molar ratio of 3:1:4; and
a crystalline form that exhibits a laminar morphology.

In an embodiment of the present disclosure, the laminar lithium vanadium oxide (Li₃VO₄) compound is characterized with lattice constants a=5.448 Å, b=6.327 Å, and c=4.949 Å.

The present disclosure relates to a metal-ion battery comprising:
an anode fabricated from the laminar Li₃VO₄ electroconductive material of claim 1;
a counter foil; and
an electrolyte,
wherein the counter foil is selected from a group comprising lithium counter foil, sodium counter foil and zinc counter foil.

In an embodiment, the foregoing descriptive matter is illustrative of the disclosure and not a limitation. While considerable emphasis has been placed herein on the particular features of this disclosure, it will be appreciated that various modifications can be made, and that many changes can be made in the preferred embodiments without departing from the principles of the disclosure. Those skilled in the art will recognize that the embodiments herein can be practiced with modification within the spirit and scope of the embodiments as described herein.

The present disclosure further relates to the following numbered embodiments describing the features of the disclosure

1. A process for preparing laminar lithium vanadium oxide (Li₃VO₄) electroconductive material, the process comprising:
a) dissolving a lithium source or salt in a solvent to obtain a Li precursor solution (solution-A);
b) dissolving a vanadium source or salt in a solvent to obtain a V precursor solution (solution-B);
c) adding the solution-A to the solution-B followed by heating, drying, and grinding it to obtain a powder 1e;
d) annealing the powder 1e to obtain a lithium vanadium oxide (Li₃VO₄);
e) grinding the Li₃VO₄ and a conductive additive to obtain a mixture 1e;
f) mixing a binder solution with the mixture 1e to obtain a slurry 1e and subsequently subjecting it to stirring to obtain a slurry-2e; and
g) coating the slurry-2e on battery-grade foil followed by evaporation to obtain the laminar lithium vanadium oxide (Li₃VO₄) electroconductive material.

2. The process of embodiment 1, wherein the electroconductive material is an anode in a metal ion battery, wherein the metal ion battery is selected from a group comprising but not limited to a lithium-ion battery, sodium ion battery, or zinc ion battery.

3. The process of embodiment 1, wherein in the step (a), the lithium source or lithium salt is selected from a group comprising lithium acetate dihydrate (LiOAc), lithium chloride (LiCl), or lithium hydroxide (LiOH) and in step (b), the vanadium source or vanadium salt is selected from a group comprising ammonium metavanadate (NH₄VO₃), Vanadyl Sulphate (VOSO₄), ammonium metavanadate (NH₄VO₃), Vanadium (V) tripropoxide oxide (OV(OC₃H₇)₃), vanadyl acetylacetonate (C₁₀H₁₄O₅V), Vanadium(V) trisisopropoxide oxide (OV(OCH(CH₃)₂)₃), and Vanadium pentoxide (V₂O₅).

4. The process of embodiment 1, wherein the Lithium acetate dihydrate (LiOAc) is dissolved in an amount of about 5 ml to 70 ml in a solvent to obtain a Li precursor solution (solution-A) under constant stirring at a speed of about 500-1200 rpm, and heating at a temperature ranging from about 20° C. to 80° C.; and wherein the ammonium metavanadate (NH₄VO₃) is dissolved in an amount of about 5 ml to 70 ml in a solvent to obtain a V precursor solution (solution-B).

5. The process of embodiment 1, wherein the solvent is selected from a group comprising ethanol, methanol, 2-methoxy ethanol, propanol, or water.

6. The process of embodiment 1, wherein the heating in step (c) is performed at a temperature ranging from about 25° C. to 80° C. for a duration ranging from about 3 hours to 30 hours and wherein the drying in step (c) is performed at a temperature ranging from about 60° C. to 110° C. for a duration of about 1 hour to 5 hours to obtain a powder 1e.

7. The process of embodiment 1, wherein in step (d) the powder 1e obtained in step (c) is annealed at a high temperature ranging from about 500° C. to 1200° C. for a duration ranging from about 1 hour to 8 hours to obtain a lithium vanadium oxide (Li₃VO₄).

8. The process of embodiment 1, wherein in the step (e), the conductive additive is a mixture of carbon black and multiwall carbon nanotube (MWCNT) or single wall carbon nanotube (SWCNT) which are in a varying ratios of about 8:2, 7:3 or 5:5, by weight of the total conductive filler used; and wherein in step (f), the binder solution is prepared by dissolving a binder selected from a group comprising polyvinylidene-fluoride (PVDF), carboxymethylcellulose (CMC), or styrene-butadiene rubber (SBR) in a solvent either water or N-methyl-2-pyrrolidinone (NMP).

9. The process of embodiment 1, wherein in the step (f), the slurry-1e is subjected to stirring at a speed ranging from about 500 rpm to 1500 rpm and ultra-sonication for a duration ranging from about 1 hour to 8 hours to obtain a slurry-2e.

10. The process of embodiment 1, wherein in the step (g) the evaporation is carried out at a temperature ranging from about 40° C. to 100° C. to obtain the electroconductive material; and wherein the battery grade foil is selected from a group comprising but not limited to Cu battery grade foil, carbon cloth battery grade foil, SS316 battery grade foil, Nickel battery grade foil, and graphite cloth battery grade foil.

11. The process of embodiment 1, wherein the ratio of active material (Li₃VO₄): conductive additive: binder is selected from a group comprising 7:2:1, 9:0.5:0.5, 8:1:1, and 7:1:2.

12. A process of embodiment 1 for preparing Li₃VO₄ anode for a metal ion battery, the process comprising:
a) dissolving lithium acetate dihydrate (LiOAc) in an amount ranging from about 10 ml to 50 ml, in a solvent to obtain a Li precursor solution (solution-A4) under constant stirring at a speed of about 750-950 rpm and heating at a temperature ranging from about 35° C. to 65° C.;
b) dissolving ammonium metavanadate (NH₄VO₃) in an amount ranging from about 10 ml to 50 ml in a solvent to obtain a V precursor solution (solution-B4);
c) adding the solution-A4 to the solution-B4 followed by heating at a temperature ranging from about 45° C. to 70° C. for a duration of about 12 hours to 24 hours, drying at a temperature ranging from about 80° C. to 95° C. for a duration of about 2 to 3 hours, and grinding it to obtain a powder 1d;
d) annealing the powder 1d at a high temperature ranging from about 700° C. to 900° C. for a duration ranging from about 3 hours to 5 hours to obtain a lithium vanadium oxide Li₃VO₄;
e) grinding the Li₃VO₄ and a conductive additive to obtain a mixture 1d;
f) mixing a binder solution with the mixture 1d to obtain a slurry-1d and subsequently subjecting it to stirring at a speed of 900 rpm to 1100 rpm and ultra-sonication for a duration of 3 hours to 6 hours to obtain a slurry-2d; and
g) coating the slurry-2d on Cu battery-grade foil followed by evaporation at a temperature ranging from about 60° C. to 80° C. to obtain the electroconductive material Li₃VO₄, wherein the metal ion battery is either lithium-ion battery or sodium-ion battery.

13. A process of embodiment 1 for preparing Li₃VO₄ anode for a Zinc ion battery, the process comprising:
a) dissolving lithium acetate dihydrate (LiOAc) in an amount ranging from about 10 ml to 50 ml, in a solvent to obtain a Li precursor solution (solution-A4) under constant stirring at a speed of about 750-950 rpm and heating at a temperature ranging from about 35° C. to 65° C.;
b) dissolving ammonium metavanadate (NH₄VO₃) in an amount ranging from about 10 ml to 50 ml in a solvent to obtain a V precursor solution (solution-B4);
c) adding the solution-A4 to the solution-B4 followed by heating at a temperature ranging from about 45° C. to 70° C. for a duration of about 12 hours to 24 hours, drying at a temperature ranging from about 80° C. to 95° C. for a duration of about 2 to 3 hours, and grinding it to obtain a powder 1d;
d) annealing the powder 1d at a high temperature ranging from about 700° C. to 900° C. for a duration ranging from about 3 hours to 5 hours to obtain a lithium vanadium oxide Li₃VO₄;
e) grinding the Li₃VO₄ and a conductive additive to obtain a mixture 1d;
f) mixing a binder solution with the mixture 1d to obtain a slurry-1d and subsequently subjecting it to stirring at a speed of 900 rpm to 1100 rpm and ultra-sonication for a duration of 3 hours to 6 hours to obtain a slurry-2d; and
g) coating the slurry-2d on a battery grade foil followed by evaporation at a temperature ranging from about 60° C. to 80° C. to obtain the electroconductive material Li₃VO₄, wherein the battery grade foil is selected from a group comprising carbon cloth, SS316 foil, Nickel foil, or graphite cloth.

14. A laminar lithium vanadium oxide (Li₃VO₄) compound, characterized by:
a layered structure;
a composition comprising lithium (Li), vanadium (V), and oxygen (O) in a molar ratio of 3:1:4; and
a crystalline form that exhibits a laminar morphology.

15. The compound of embodiment 14, wherein the laminar lithium vanadium oxide (Li₃VO₄) compound is characterized with lattice constants a=5.448 Å, b=6.327 Å, and c=4.949 Å.

16. A metal-ion battery comprising:
an anode fabricated from the laminar Li₃VO₄ electroconductive material of embodiment 1;
a counter foil; and
an electrolyte,
   wherein the counter foil is selected from a group comprising lithium counter foil, sodium counter foil and zinc counter foil.

The present disclosure is further defined in the following examples. It should be understood that these examples indicating exemplary embodiments of the present disclosure are given by way of illustration only and should not be construed to limit the scope of the disclosure. From the above discussion and these examples, one skilled in the art can ascertain the essential characteristics of this disclosure, and without departing from the spirit and scope thereof, can make various changes and modifications of the disclosure to adapt it to various uses and conditions.

### EXAMPLES

### Example 1: Synthesis of Li₃VO₄ (LVO)

### Chemicals:

The starting materials used in the experiment were of analytical grade and purchased from sigma aldrich, alfa aesar, SRL thermo fisher, etc.

Synthesis of Li₃VO₄ (LVO):

The synthesis of Li₃VO₄ (LVO) was carried out via a solution-processed route.

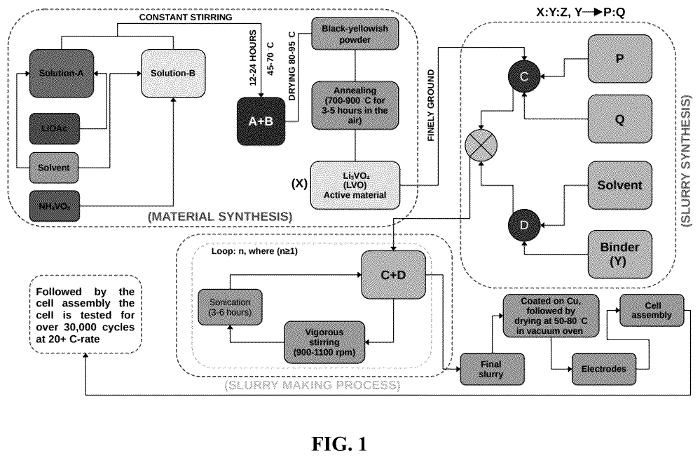

In the synthesis process, 1.1275 grams of LiOAc (Lithium acetate dihydrate), which is the source of Li precursor, was dissolved in 25 ml of 2-methoxy ethanol under constant stirring (750-950 rpm) at 35-65° C. till it completely dissolved (solution-A5). Similarly, V precursor solution was prepared by dissolving 0.431 grams of NH₄VO₃ in 25 ml of 2-methoxy ethanol (solution-B5). The solutions (A5 and B5) were homogeneously mixed individually for 20-30 minutes under constant stirring. Solution-A5 was added drop-wise in solution-B5, and the reaction was then carried out for 12-24 hours at 45-70° C. A black-yellowish powder sample was collected and appropriately ground after drying the solution mixture (gel) at 80-95° C. in air for 2-3 hours. Finally, a white powdered LVO was obtained after annealing a black-yellowish powder sample at a high temperature between 700-900° C. for 3-5 hours in the air. FIG. 1 shows the schematic representation of LVO synthesis via the sol-gel route.

Characterization of Li₃VO₄ (LVO):

The X-ray diffraction (XRD), Field emission scanning electron microscopy (FESEM), and Transmission electron microscope (TEM) (including Selected area electron diffraction (SAED)) confirmed the morphology and crystalline phase of the LVO, as shown in FIG. 2. Powder X-ray diffraction pattern (PXRD, Rigaku Ultima) reveals an orthorhombic phase with the Pmn21 space group (confirmed with JCPDS Card No. 38-1247) and with Rietveld refinement (TOPAS) yielding lattice constants: a=5.448 Å, b=6.327 Å, and c=4.949 Å. No impurity diffraction peaks were observed, suggesting the pure phase of LVO.

### Example 2: Process of Slurry Preparation and Device Fabrication

The electrodes were fabricated by making a homogeneous slurry of active materials (LVO) in a particular ratio with conductive additive, solvent N-methyl-2-pyrrolidinone (NMP), water but not limited to this only), and binder (polyvinylidene-fluoride (PVDF), carboxymethylcellulose (CMC), styrene-butadiene rubber (SBR) but not limited to this only) The said binders can be used individually or in combination. The ratio of active material: conductive additive: binder is 7:2:1.

In this process, LVO and the conductive additive were first finely ground together using a mortar pestle. Meanwhile, the solvent and binder were stirred and heated (35-65° C.) until the binder completely dissolved. Afterwards, everything was mixed, and the volume of solvent was tuned to make the viscosity of the slurry optimum for the coating. The slurry was vigorously stirred at high rpm (900-1100 rpm), followed by ultra-sonication for 3-6 hours. The above process is repeated for n times where n>1. The slurry was then coated on Cu battery-grade foil and was kept overnight inside the vacuum oven at an elevated temperature between 60-80° C. until the residual solvent completely evaporated. Afterwards, the electrodes were finally punched from the dried slurry of a disc size 10 mm, followed by cell assembly. The detailed schematic flow diagram of the above process is represented in FIG. 1.

### For Battery Fabrication:

A batch size of 0.5 g is selected for the fabrication of slurry, followed by devices.

A ratio of 7:2:1 is selected.
(a) Mass of active material (LVO): 0.35 g
(b) Mass of conductive filler: 0.1 g

The conductive filler is further divided into two parts:
mass of carbon black: 0.08 g
mass of MWCNT: 0.02 g
Total: 0.1 g (which is of conductive filler)
(c) Mass of PVDF binder: 0.05 g
Total: 0.35+0.08+0.02+0.05=0.5 g (batch size selected)
The volume of NMP is tuned to make the slurry viscous enough for the coating.

### Example 3: Electrochemical Testing

LVO half-cell was tested on CR2016 cell configuration under a potential window 3-0.02 V at 20+ C-rate (current density: ˜12-14 Å/g) for 30000 cycles. At such a high C-rate, the cell delivered a specific discharge capacity of 150-170 mAh/g at the 15000^{th} cycle with a coloumbic efficiency (CE) of >95%. Under such persistent deep charging, the cell can still deliver a capacity of 100-160 mAh/g at the end of 30K cycles. Considering the initial and final capacity of the Galvanostatic charge discharge cycle (GCD) profile of the LVO, the capacity initially fell for a few cycles. However, it then started increasing for the rest of the cycles. Considering a rough estimate of the fading in the discharge capacity between 15K to 30 K cycles, the numeric value comes to around <0.002 mAh/g. The overall GCD profile and time vs current/voltage profile is shown in Figure (3). The increasing capacity of the cell could be due to the unique laminar structure of the LVO. Surprisingly, the unique laminar structure is achieved by the solution process route and embodying the mentioned production conditions.

Under high-stress conditions (fast charge-discharging rates), an increased gap between the sheets may occur during prolonged cycling. The sheet morphology remains intact even after 30K cycles under a constant 20+C rate, as shown in FIG. (2e). Table. (1) shows some recent literature comparisons on the Li₃VO₄. In our work, GCD cycling is done on the current density, which is the highest. Also, the capacity falls for a few initial cycles but rises until it becomes close to the overall average specific discharge capacity. Considering the capacity fading per cycle by taking average capacity as a reference, it came to around <0.0003 mAh/g, which is regarded as excellent in cell performance under high rates and long cycling. The above process of synthesis and fabrication leads to the formation of nanosheets of Li₃VO₄.

In Table 1, within the context of the present invention, GCD cycling is conducted at the highest current density. Despite a slight initial decrease in capacity, it progressively improves until it reaches a level close to the overall average specific discharge capacity. Evaluating the capacity fading per cycle relative to the average capacity, it is found to be approximately <0.0003 mAh/g, indicating exceptional cell performance under high rates and extended cycling conditions.

### Example 4

### Electrochemical Performance of LVO∥Li:

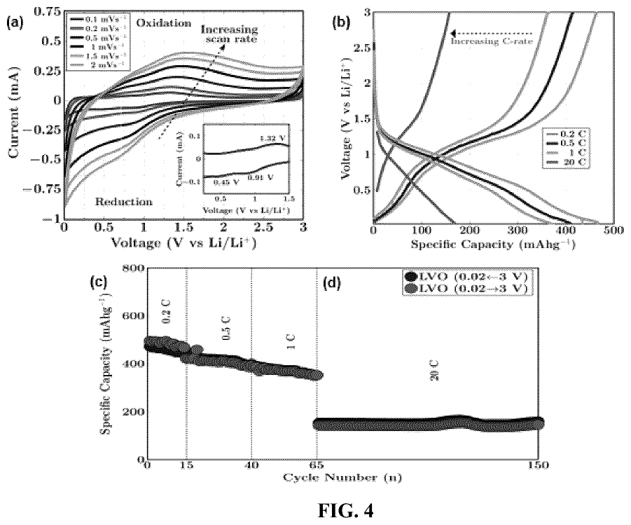

FIG. 4 depicts (a) Cyclic voltammogram (CV) test under various scan rate (0.1-2 mV/s), (b) charge-discharge profile under various C-rate, and (c) rate capability (RC) test of LVO∥Li half-cell under various C-rates (0.2, 0.5, 1 and 20 C) between potential window of 0.02-3 V.

### Inference:

The cyclic voltammetry (CV) test on the LVO∥Li cell reveals two prominent reduction peaks at 0.91 V and 0.45 V, along with an oxidation peak at 1.32 V, recorded at a scan rate of 0.1 mV/s within a potential window of 0.02-3 V. The CV profile retains its typical shape even at higher scan rates, indicating low polarization in the material structure. The rate capability (RC) performance test shows that the cell delivers capacities of approximately 472 mAh/g at 0.2 C, 433.2 mAh/g at 0.5 C, 391.7 mAh/g at 1 C, and 153.57 mAh/g at 20 C. Even with abrupt changes in the charging and discharging rates over 15-25 cycles, the cell maintains stable operation. The mass loading of the electrode is maintained between 1.2-2.5 mg/cm².

### Example 5: Fabrication of LVO∥Na Half-Cell

The electrodes were fabricated by making a homogenous slurry of active materials (LVO) in a particular ratio with conductive additive, solvent (NMP, water but not limited to this only), and binder (PVDF, CMC, SBR but not limited to this only). In this process, LVO and the conductive additive were first finely ground together using a mortar pestle. Meanwhile, the solvent and binder were stirred and heated (35-65° C.) until the binder completely dissolved. Afterwards, everything was mixed, and the volume of solvent was tuned to make the viscosity of the slurry optimum for the coating. The slurry was vigorously stirred at high rpm (900-1100 rpm), followed by ultra-sonication for 3-6 hours. The above process is repeated for n times where n>1. The slurry was then coated on Cu battery-grade foil and was kept overnight inside the vacuum oven at an elevated temperature between 60-80° C. until residual solvent completely evaporated. Afterwards, the electrodes were finally punched from the dried slurry of a disc size 10 mm, followed by cell assembly. During cell assembly electrolyte used in the fabrication of LVO∥Na cell is 1 M NaPF6 (Sodium hexafluorophosphate) in EC:DMC 1:1 (ethylene carbonate and dimethyl carbonate) with 2% FEC (Fluoroethylene carbonate) additive.

### Electrochemical Performance of LVO∥Na:

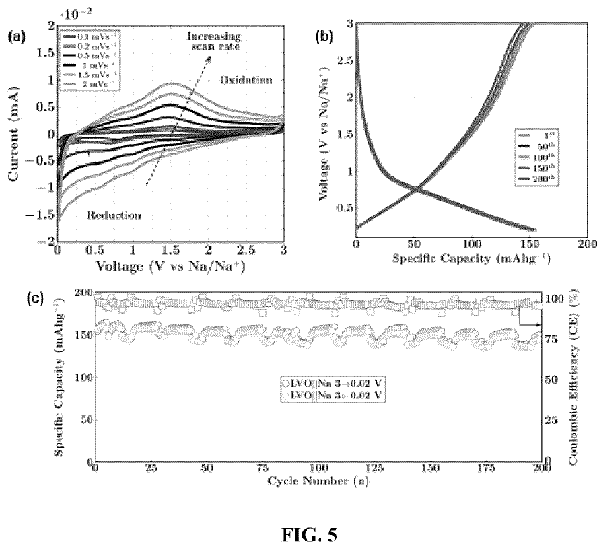

FIG. 5 depicts (a) Cyclic voltammogram (CV) test under various scan rate (0.1-2 mV/s), (b) charge-discharge profile at 0.1 C, and (c) GCD cycling performance of LVO∥Na half-cell for 200 cycles at 0.2 C under potential window of 0.02-3 V.

### Inference:

The cyclic voltammetry (CV) test on the LVO∥Na cell shows one prominent oxidation peak at 1.45 V and a prominent reduction peak at 0.76 V. Additionally, a smaller peak appears during the reduction phase at 1.63 V. Still, its intensity is lower than the peak at 0.76 V, recorded at a scan rate of 0.1 mV/s under potential window of 0.02-3 V. The cell was also tested at higher scan rates, up to 2 mV/s. The overall CV shape remains consistent, indicating lower polarization during sodium interaction with the anode. The galvanostatic charge-discharge (GCD) cycling of the LVO∥Na cell shows an initial discharge capacity of 153.7 mAh/g for the 1” cycle and 149.75 mAh/g for the 200th cycle at 0.2 C, resulting in a capacity retention of 97.4%. Although some fluctuations in the GCD cycling are observed due to changes in ambient temperature, the cell maintains a coulombic efficiency above 95% throughout the cycling. The mass loading of the electrode is maintained between 1.2-2.5 mg/cm²

### Example 6: Fabrication of LVO∥Zn Half-Cell

The electrodes were fabricated by making a homogenous slurry of active materials (LVO) in a particular ratio with conductive additive, solvent (NMP, water but not limited to this only), and binder (PVDF, CMC, SBR but not limited to this only). In this process, LVO and the conductive additive were first finely ground together using a mortar pestle. Meanwhile, the solvent and binder were stirred and heated (35-65° C.) until the binder completely dissolved. Afterwards, everything was mixed, and the volume of solvent was tuned to make the viscosity of the slurry optimum for the coating. The slurry was vigorously stirred at high rpm (900-1100 rpm), followed by ultra-sonication for 3-6 hours. The above process is repeated for n times where n>1. The slurry was then coated on carbon cloth, SS316 foil, Nickel foil, graphite cloth (but not limited to this) battery-grade foil and was kept overnight inside the vacuum oven at an elevated temperature between 60-80° C. until residual solvent completely evaporated. Afterwards, the electrodes were finally punched from the dried slurry of a disc size 10 mm, followed by cell assembly. During cell assembly electrolyte used in the fabrication of LVO∥Zn cell is 2 M ZnSO₄ in DI water.

The molarity range of ZnSO₄ aqueous electrolyte is between 1 to 4 M.

### Electrochemical Performance of LVO∥Zn:

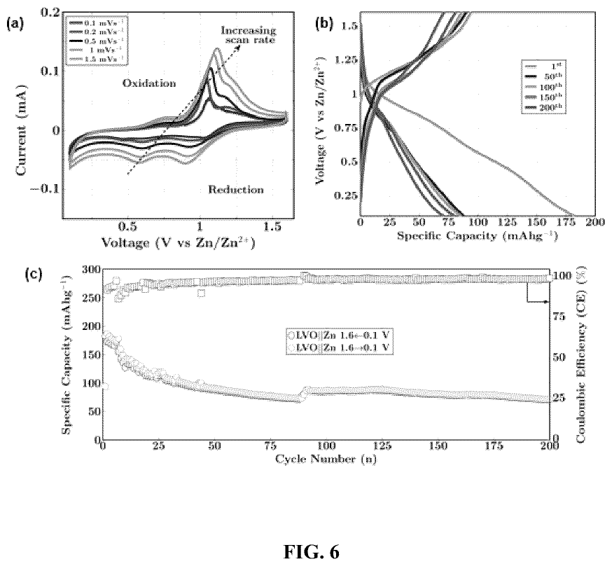

FIG. 6 depicts (a) Cyclic voltammogram (CV).test under various scan rate (0.1-1.5 mV/s), (b) charge-discharge profile at 0.15 C, and (c) GCD cycling performance of LVO∥Zn half-cell for 200 cycles at 0.15 C under potential window of 0.2-1.6 V.

### Inference:

The cyclic voltammetry (CV) test on the LVO∥Zn cell shows one prominent oxidation peak at 1.05 V and three smaller reduction peaks at 1.01 V, 0.57 V, and 0.47 V. The cell was tested at higher scan rates, up to 1.5 mV/s. The cell's galvanostatic charge-discharge (GCD) cycling shows an initial discharge capacity of 182.62 mAh/g for the first cycle, which decreases to 71.05 mAh/g by the 200th cycle. This capacity fading is attributed to the divalent nature of the Zn ion, which is larger than other metal ions. The mass loading of the electrode is maintained between 2-3 mg/cm².

TABLE 1
Comparative study of LVO synthesis and its cell performance in LIBs.

| | | | | | Final | C-rate/ | | | |
|---|---|---|---|---|---|---|---|---|---|
| | | | | | discharge | Current | | Capacity | |
| | | | Potential | | Capacity | density | | retention | |
| Material | Synthesis route | Morphology | Window | | (mAh/g) | (A/g) | Cycles | (%) | Ref |
| Li₃VO₄/NC | Hydrogel- | Sponge | 0.01-3 | V | 266 | (4 A/g | 4000 | — | [11] |
| | assisted | structure | | | | charging, | | | |
| | freeze drying | | | | | and 8 A/g | | | |
| | | | | | | discharging) | | | |
| In, | Electrospining | Nanofibers | 0.2-3 | V | 259.5 | 1.6 | 4000 | 78.7 | [12] |
| Ce—Li₃VO₄/NC | | | | | | | | | |
| Li₃VO₄ | microwave | hollow | 0.2-3 | V | 299.6 | 0.2 | 500 | 99.0 | [13] |
| | irradiation | nanosphere | | | | | | | |
| | strategy | | | | | | | | |
| Li₃VO₄/VGCF | Hydrothermal | Nanoparticles | 0.01-3 | V | 322.6 | 5 C | 500 | — | [14] |
| | followed by CVD | decorated with | | | | | | | |
| | | VG carbon fibre | | | | | | | |
| Li₃VO₄@C | Solvothermal | microspheres | 1.1-3 | V | 233 | 4 | 1000 | 94 | [15] |
| Li₃VO₄ | Solvothermal | Nanorods | 0.1-3 | V | 440 | 0.1 | 100 | 72 | [16] |
| Li₃VO₄/C/rGO | Spray drying | Deflated | 0.02-3 | V | 350 | 2 | 1000 | 92.1 | [17] |
| | | balloon like | | | | | | | |
| | | microspheres | | | | | | | |
| Ag—Li₃VO₄ | Hydrothermal | Nanoparticles | 0.02-3 | V | 479 | 0.15 | 150 | — | [18] |
| | | aggregates | | | | | | | |
| F—Li₃VO₄ | sol gel | Nanoparticles | 0.01-3 | V | 450 | 0.5 | 1100 | — | [19] |
| | (chelating | with micron- | | | | | | | |
| | agent = citric | sized rods | | | | | | | |
| | acid is used) | like aggregates | | | | | | | |
| Li₃VO₄ | microwave | Nanocrystals | 0.2-3 | V | 104 | 0.1 | 100 | 96 | [20] |
| | assisted | aggregates | | | | | | | |
| | hydrothermal | | | | | | | | |
| Li₃VO₄ | Surfactant free | Nanosheets | 0.02-3 | V | 100-160 | ~12-14 A/g | Over | >93^{†} | This |
| | sol-gel process | (crystalline | | | | (20+ C-rate) | 30,000 | | work |
| | | phase) | | | | | | | |

^{†}In the present work, capacity retention cannot be calculated directly from the initial and final capacity over a very long cycling profile. Therefore, the capacity retention was calculated by taking average capacity as a reference which is discussed in the subsequent section. Also, such variations in capacity over the long-term cycling and numeric ratio between initial and final capacity may not justify the cell's performance. That is why inventors have considered average capacity also because, after a few initial cycles, the cell capacity starts rising; if we calculate the CR from that point, then it always comes to >100%, and the reason for the capacity increase is subjected to the high degree of charge and discharge rates which creates a gap between the laminar (layered) structure of LVO, ultimately leads to accommodate more Li+ ions in the subsequent cycles.

TABLE 2
Recent patents related to Li3VO4 (LVO) synthesis and its cell performance.

| | | | | Intial/Final | | | | |
|---|---|---|---|---|---|---|---|---|
| | | | | discharge | C-rate/Current | | | |
| | | | Potential | capacity | density (A/g) | | | |
| Material | Synthesis route | Morphology | Window | (mAh/g) | or mA/cm² | | Cycles | Patent no. |
| Carbon | Hydrothermal | Nanoparticles | 0.01-3 V | 620/498 | 0.1 | mA/cm² | 100 | CN104201363A |
| coated | | (90-120 nm) | | | | | | |
| Li₃VO₄ | | | | | | | | |
| Nitrogen | Hydrothermal | Nanoparticles | 3-0.02 V | 483/607 | (NA) | | 100 | CN104852054A |
| doped | | of range dia = | | | | | | |
| Carbon | | 100 nm | | | | | | |
| coated | | | | | | | | |
| Li₃VO₄ | | | | | | | | |
| Li₃VO₄/C | Electrospinning | nanofibers | 0.01-3 V | 848.7/627 | 0.2 | A/g | 50 | CN113699687B |
| Li₃VO₄/C | Electrospinning | nanofibers | 0.01-3 V | 787.6/608.7 | 0.5 | A/g | 50 | CN112281258A |

| | | | | | | | |
|---|---|---|---|---|---|---|---|
| Graphite/ | hydrothermal | Li₃VO₄ | 0.01-3 V | 367/527 | (NA) | 100 | CN104124446A |
| Li₃VO₄ | | nanoparticle | | | | | |
| | | (coated on | | | | | |
| | | graphite | | | | | |
| | | surface, | | | | | |
| | | average- | | | | | |
| | | size ~100 nm) | | | | | |
| Binder-free | hydrothermal | Nanogranular | 0.02-3 V | 429/712 | (NA) | 100 | CN104868119A |
| Li₃VO₄/C | | of 200 nm size | | | | | |
| Li₃VO₄ | microwave | Hollow | (NA) | 446/280 | (NA) | (NA) | CN106356522A |
| | synthesis | nanocubes | | | | | |

In Table 2, it is evident that the C rate and cyclic performance in prior patent documents are inferior compared to the present case, primarily due to the limited capacity of up to only 100 cycles in the prior art.

On the other hand, the present laminar lithium vanadium oxide (Li₃VO₄) electroconductive material was tested under high C-rate (>20 C). The laminar structure results in more spacing for the lithium ion during intercalation (discharging), which results in stable operation over long-term cycling. FIG. 2 shows ex-situ HRTEM scan image for the LVO cycled cell after 30K cycling, which clearly demonstrates that there is no distortion in the overall morphology of the LVO, which results in the above high cycling.

Although the invention has been described concerning specific embodiments, this description is not meant to be construed in a limiting sense. Various modifications of the disclosed embodiments and alternate embodiments of the invention will become apparent to persons skilled in the art upon reference to the description of the invention. It is therefore contemplated that such modifications can be made without departing from the spirit or scope of the present invention as defined.

### REFERENCES

[1] S. Di et al., “Hierarchical microspheres assembled from Li₄Ti₅O₁₂—TiO₂ nanosheets with advanced lithium ion storage,” Ionics, vol. 26, no. 6, pp. 2763-2772, June 2020, doi: 10.1007/s11581-020-03452-5.
[2] G.-N. Zhu, Y-G. Wang, and Y-Y Xia, “Ti-based compounds as anode materials for Li-ion batteries,” Energy Environ. Sci., vol. 5, no. 5, pp. 6652-6667, April 2012, doi: 10.1039/C2EE03410G.
[3] D. Aurbach, E. Zinigrad, Y Cohen, and H. Teller, “A short review of failure mechanisms of lithium metal and lithiated graphite anodes in liquid electrolyte solutions,” Solid State Ion., vol. 148, no. 3, pp. 405-416, June 2002, doi: 10.1016/S0167-2738(02)00080-2.
[4] D. Zhao and M. Cao, “Constructing Highly Graphitized Carbon-Wrapped Li₃VO₄ Nanoparticles with Hierarchically Porous Structure as a Long Life and High Capacity Anode for Lithium-Ion Batteries,” ACS Appl. Mater. Interfaces, vol. 7, no. 45, pp. 25084-25093, November 2015, doi: 10.1021/acsami.5b05269.
[5] X. Wang et al., “Facile Synthesis of Carbon-Coated Li₃VO₄ Anode Material and its Application in Full Cells,” Energy Technol., vol. 6, no. 10, pp. 2074-2081, 2018, doi: 10.1002/ente.201800186.
[6] C. Zhang et al., “Effects of high surface energy on lithium-ion intercalation properties of Ni-doped Li₃VO₄,” NPG Asia Mater., vol. 8, no. 7, Art. no. 7, July 2016, doi: 10.1038/am.2016.95.
[7] Z. Liang et al., “The low and high temperature electrochemical performance of Li₃VO₄/C anode material for Li-ion batteries,” J. Electroanal. Chem., vol. 745, pp. 1-7, May 2015, doi: 10.1016/j.jelechem.2015.03.013.
[8] P. Qin, X. Lv, C. Li, Y.-Z. Zheng, and X. Tao, “Morphology inheritance synthesis of carbon-coated Li₃VO₄ rods as anode for lithium-ion battery,” Sci. China Mater., vol. 62, no. 8, pp. 1105-1114, August 2019, doi: 10.1007/s40843-019-9424-9.
[9] Q. Li et al., “Mesoporous Li₃VO₄/C Submicron-Ellipsoids Supported on Reduced Graphene Oxide as Practical Anode for High-Power Lithium-Ion Batteries,” Adv. Sci., vol. 2, no. 12, p. 1500284, 2015, doi: 10.1002/advs.201500284.
[10] M. E. Arroyo-de Dompablo, P. Tartaj, J. M. Amarilla, and U. Amador, “Computational Investigation of Li Insertion in Li₃VO₄,” Chem. Mater., vol. 28, no. 16, pp. 5643-5651, August 2016, doi: 10.1021/acs.chemmater.6b01519.
[11] X. Bai et al., “Construction of hierarchical Li₃VO₄/NC sponge structure for high-performance lithium storage,” Electrochimica Acta, vol. 462, p. 142807, September 2023, doi: 10.1016/j.electacta.2023.142807.
[12] Y Wan et al., “In/Ce Co-doped Li₃VO₄ and Nitrogen-modified Carbon Nanofiber Composites as Advanced Anode Materials for Lithium-ion Batteries,” ACS Appl. Mater. Interfaces, vol. 14, no. 47, pp. 52702-52714, November 2022, doi: 10.1021/acsami.2c10471.
[13] Y Sun et al., “Novel Li₃VO₄ Nanostructures Grown in Highly Efficient Microwave Irradiation Strategy and Their In-Situ Lithium Storage Mechanism,” Adv. Sci., vol. 9, no. 3, p. 2103493, 2022, doi: 10.1002/advs.202103493.
[14] J. Song et al., “One-dimensional Li₃VO₄/carbon fiber composites for enhanced electrochemical performance as an anode material for lithium-ion batteries,” J Mater. Sci. Technol., vol. 140, pp. 142-152, March 2023, doi: 10.1016/j.jmst.2022.09.010.
[15] X. Liu et al., “Carbon coated Li₃VO₄ microsphere: Ultrafast solvothermal synthesis and excellent performance as lithium-ion battery anode,” J Power Sources, vol. 493, p. 229680, May 2021, doi: 10.1016/j.jpowsour.2021.229680.
[16] G. Yang et al., “Morphology controlled lithium storage in Li₃VO₄ anodes,” J Mater. Chem. A, vol. 6, no. 2, pp. 456-463, January 2018, doi: 10.1039/C7TA09023D.[17] H. Liu et al., “Boosting the Deep Discharging/Charging Lithium Storage Performances of Li₃VO₄ through Double-Carbon Decoration,” ACS Appl. Mater. Interfaces, vol. 10, no. 28, pp. 23938-23944, July 2018, doi: 10.1021/acsami.8b08483.
[18] T. Kang et al., “Ag Embedded Li₃VO₄ as Superior Anode for Li-Ion Batteries,” J Electrochem. Soc., vol. 166, no. 3, p. A5295, January 2019, doi: 10.1149/2.0381903jes.
[19] X. Liu, G. Li, D. Zhang, L. Meng, B. Li, and L. Li, “F doped Li₃VO₄: An advanced anode material with optimized rate capability and durable lifetime,” Electrochimica Acta, vol. 354, p. 136655, September 2020, doi: 10.1016/j.electacta.2020.136655.
[20] G. S. Zakharova, E. Thauer, S. A. Wegener, J.-H. Nolke, Q. Zhu, and R. Klingeler, “Hydrothermal microwave-assisted synthesis of Li₃VO₄ as an anode for lithium-ion battery,” J. Solid State Electrochem., vol. 23, no. 7, pp. 2205-2212, July 2019, doi: 10.1007/s10008-019-04315-4.

We claim:

1. A process for preparing laminar lithium vanadium oxide (Li₃VO₄) electroconductive material, the process comprising:
a) dissolving a lithium source or salt in a solvent to obtain a Li precursor solution (solution-A);
b) dissolving a vanadium source or salt in a solvent to obtain a V precursor solution (solution-B);
c) adding the solution-A to the solution-B followed by heating, drying, and grinding it to obtain a powder 1e;
d) annealing the powder 1e to obtain a lithium vanadium oxide (Li₃VO₄);
e) grinding the Li₃VO₄ and a conductive additive to obtain a mixture 1e;
f) mixing a binder solution with the mixture 1e to obtain a slurry 1e and subsequently subjecting it to stirring to obtain a slurry-2e; and
g) coating the slurry-2e on battery-grade foil followed by evaporation to obtain the laminar lithium vanadium oxide (Li₃VO₄) electroconductive material.

2. The process of claim 1, wherein the electroconductive material is an anode in a metal ion battery, wherein the metal ion battery is selected from a group comprising but not limited to a lithium-ion battery, sodium ion battery, and zinc ion battery.

3. The process of claim 1, wherein in the step (a), the lithium source or lithium salt is selected from a group comprising lithium acetate dihydrate (LiOAc), lithium chloride (LiCl), and lithium hydroxide (LiOH) and in step (b), the vanadium source or vanadium salt is selected from a group comprising ammonium metavanadate (NH₄VO₃), Vanadyl Sulphate (VOSO₄), ammonium metavanadate (NH₄VO₃), Vanadium (V) tripropoxide oxide (OV(OC₃H₇)₃), vanadyl acetylacetonate (C₁₀H₁₄O₅V), Vanadium(V) trisisopropoxide oxide (OV(OCH(CH₃)₂)₃), and Vanadium pentoxide (V₂O₅).

4. The process of claim 1, wherein the lithium acetate dihydrate (LiOAc) is dissolved in an amount of about 5 ml to 70 ml in a solvent to obtain a Li precursor solution (solution-A) under constant stirring at a speed of about 500-1200 rpm, and heating at a temperature ranging from about 20° C. to 80° C.; and wherein the ammonium metavanadate (NH₄VO₃) is dissolved in an amount of about 5 ml to 70 ml in a solvent to obtain a V precursor solution (solution-B).

5. The process of claim 1, wherein the solvent is selected from a group comprising ethanol, methanol, 2-methoxy ethanol, propanol, and water.

6. The process of claim 1, wherein the heating in step (c) is performed at a temperature ranging from about 25° C. to 80° C. for a duration ranging from about 3 hours to 30 hours; and wherein the drying in step (c) of claim 1 is performed at a temperature ranging from about 60° C. to 110° C. for a duration of about 1 hour to 5 hours to obtain the powder 1e.

7. The process of claim 1, wherein in step (d), the powder 1e obtained in step (c) of claim 1 is annealed at a high temperature ranging from about 500° C. to 1200° C. for a duration ranging from about 1 hour to 8 hours to obtain the lithium vanadium oxide (Li₃VO₄).

8. The process of claim 1, wherein in the step (e), the conductive additive is a mixture of carbon black and multiwall carbon nanotube (MWCNT) or single wall carbon nanotube (SWCNT) which are in a varying ratios of about 8:2, 7:3 or 5:5, by weight of the total conductive filler used; and wherein in step (f), the binder solution is prepared by dissolving a binder selected from a group comprising polyvinylidene-fluoride (PVDF), carboxymethylcellulose (CMC), or styrene-butadiene rubber (SBR) in a solvent either water or N-methyl-2-pyrrolidinone (NMP).

9. The process of claim 1, wherein in the step (f), the slurry-1e is subjected to stirring at a speed ranging from about 500 rpm to 1500 rpm and ultra-sonication for a duration ranging from about 1 hour to 8 hours to obtain the slurry-2e.

10. The process of claim 1, wherein in the step (g) the evaporation is carried out at a temperature ranging from about 40° C. to 100° C. to obtain the electroconductive material; and wherein the battery grade foil is selected from a group comprising but not limited to Cu battery grade foil, carbon cloth battery grade foil, SS316 battery grade foil, Nickel battery grade foil, and graphite cloth battery grade foil.

11. The process of claim 1, wherein the ratio of active material (Li₃VO₄): conductive additive: binder is selected from a group comprising 7:2:1, 9:0.5:0.5, 8:1:1, and 7:1:2.

12. A process for preparing Li₃VO₄ anode for a metal ion battery, comprising:
a) dissolving lithium acetate dihydrate (LiOAc) in an amount ranging from about 10 ml to 50 ml, in a solvent to obtain a Li precursor solution (solution-A4) under constant stirring at a speed of about 750-950 rpm and heating at a temperature ranging from about 35° C. to 65° C.;
b) dissolving ammonium metavanadate (NH₄VO₃) in an amount ranging from about 10 ml to 50 ml in a solvent to obtain a V precursor solution (solution-B4);
c) adding the solution-A4 to the solution-B4 followed by heating at a temperature ranging from about 45° C. to 70° C. for a duration of about 12 hours to 24 hours, drying at a temperature ranging from about 80° C. to 95° C. for a duration of about 2 to 3 hours, and grinding it to obtain a powder 1d;
d) annealing the powder 1d at a high temperature ranging from about 700° C. to 900° C. for a duration ranging from about 3 hours to 5 hours to obtain a lithium vanadium oxide Li₃VO₄;
e) grinding the Li₃VO₄ and a conductive additive to obtain a mixture 1d;
f) mixing a binder solution with the mixture 1d to obtain a slurry-1d and subsequently subjecting it to stirring at a speed of 900 rpm to 1100 rpm and ultra-sonication for a duration of 3 hours to 6 hours to obtain a slurry-2d; and
g) coating the slurry-2d on Cu battery-grade foil followed by evaporation at a temperature ranging from about 60° C. to 80° C. to obtain the electroconductive material Li₃VO₄, wherein the metal ion battery is either lithium-ion battery or sodium-ion battery.

13. A process for preparing Li₃VO₄ anode for a Zinc ion battery, comprising:
a) dissolving lithium acetate dihydrate (LiOAc) in an amount ranging from about 10 ml to 50 ml, in a solvent to obtain a Li precursor solution (solution-A4) under constant stirring at a speed of about 750-950 rpm and heating at a temperature ranging from about 35° C. to 65° C.;
b) dissolving ammonium metavanadate (NH₄VO₃) in an amount ranging from about 10 ml to 50 ml in a solvent to obtain a V precursor solution (solution-B4);
c) adding the solution-A4 to the solution-B4 followed by heating at a temperature ranging from about 45° C. to 70° C. for a duration of about 12 hours to 24 hours, drying at a temperature ranging from about 80° C. to 95° C. for a duration of about 2 to 3 hours, and grinding it to obtain a powder 1d;
d) annealing the powder 1d at a high temperature ranging from about 700° C. to 900° C. for a duration ranging from about 3 hours to 5 hours to obtain a lithium vanadium oxide Li₃VO₄;
e) grinding the Li₃VO₄ and a conductive additive to obtain a mixture 1d;
f) mixing a binder solution with the mixture 1d to obtain a slurry-1d and subsequently subjecting it to stirring at a speed of 900 rpm to 1100 rpm and ultra-sonication for a duration of 3 hours to 6 hours to obtain a slurry-2d; and
g) coating the slurry-2d on a battery grade foil followed by evaporation at a temperature ranging from about 60° C. to 80° C. to obtain the electroconductive material Li₃VO₄, wherein the battery grade foil is selected from a group comprising carbon cloth, SS316 foil, Nickel foil, and graphite cloth.

14. A laminar lithium vanadium oxide (Li₃VO₄) compound, characterized by:
a layered structure;
a composition comprising lithium (Li), vanadium (V), and oxygen (O) in a molar ratio of 3:1:4; and
a crystalline form that exhibits a laminar morphology.

15. The compound of claim 14, wherein the laminar lithium vanadium oxide (Li₃VO₄) compound is characterized with lattice constants a=5.448 Å, b=6.327 Å, and c=4.949 Å.

16. A metal-ion battery, comprising:
an anode fabricated from the laminar Li₃VO₄ electroconductive material of claim 1;
a counter foil; and
an electrolyte,
wherein the counter foil is selected from a group comprising lithium counter foil, sodium counter foil and zinc counter foil.
